(19) United States
(12) Patent Application Publication
(10) Pub. No.: US 2024/0204450 A1
(43) Pub. Date: Jun. 20, 2024

(54) CONNECTOR

(71) Applicant: Japan Aviation Electronics Industry, Limited, Tokyo (JP)

(72) Inventors: Takumi KINOSHITA, Tokyo (JP); Akihiro MATSUNAGA, Tokyo (JP)

(21) Appl. No.: 18/484,606

(22) Filed: Oct. 11, 2023

(30) Foreign Application Priority Data
Dec. 15, 2022 (JP) 2022-200072

(51) Int. Cl. H01R 13/58

(52) U.S. Cl. CPC H01R 13/58

(57) ABSTRACT

A connector includes a housing accommodating an end of the connection object and an end of the electric wire, the connection object and the conductor portion of the electric wire making contact with and being electrically connected to each other in the housing, the housing having an electric wire lead-out port leading out the electric wire from inside to outside of the housing, the electric wire lead-out port having a first contact portion and a second contact portion that make contact with the electric wire at two positions separate away from each other along a length direction of the electric wire so as to disperse a load applied to the electric wire when the electric wire is led out from the housing at a predetermined minimum bending radius determined by a shape of the housing around the electric wire lead-out port.

### BACKGROUND OF THE INVENTION

The present invention relates to a connector, particularly to a connector for connecting a conductor portion of an electric wire to a flexible conductor of a sheet type conductive member.

In recent years, attention has been drawn to so-called smart clothes that can obtain user's biological data such as the heart rate and the body temperature only by being worn by the user. Such smart clothes have an electrode disposed at a measurement site and constituted of a flexible conductor, and when a wearable device serving as a measurement device is electrically connected to the electrode, biological data can be transmitted to the wearable device.

The electrode and the wearable device can be interconnected by, for instance, use of a connector connected to the flexible conductor.

However, when the wearable device is situated away from the measurement site, it is necessary to provide an electric path connecting the electrode disposed at the measurement site to the place where the connector is attached, and if such an electric path is formed from a flexible conductor, this causes higher electric resistance and higher cost.

To interconnect an electrode constituted of a flexible conductor and a wearable device by use of an electric wire that has low electric resistance and is inexpensive, the development of a small-sized connector connecting the electric wire to the flexible conductor disposed on a garment is in progress.

When an electric wire is connected to a flexible conductor by use of such a connector, tensile forces are applied to the electric wire from various directions due to movement of a garment and other factors, so that a bent portion is formed in the electric wire led out from the connector, and when curvature of this bent portion decreases, a conductor portion of the electric wire may be broken.

As a device for protecting an electric wire that is to be bent, for example, JPH05-266944A discloses a cable protection device for a modular plug, the device including a bendable bushing member as shown in FIG. 26. A bushing member 2 is attached to a rear portion of a modular plug 1. The bushing member 2 is made of rubber or the like and is bendable, and has a through-hole 4 through which a cable 3 is passed. A front end of the cable 3 is disposed inside the modular plug 1 through the through-hole 4 of the bushing member 2, and a core wire 5 of the cable 3 is inserted in a core wire insertion hole 6 of the modular plug 1 and electrically connected to a contact terminal 7 disposed at a side portion of the core wire insertion hole 6.

With the device disclosed in JPH05-266944A, even when tensile forces are applied to the cable 3 from various directions, due to the presence of the bendable bushing member 2, the cable 3 is bent at large curvature as shown by two dot chain line, whereby the core wire 5 of the cable 3 can be prevented from being broken.

However, the bendable bushing member 2 made of rubber or the like needs to be attached to the modular plug 1, so that the number of components and production cost increase.

### SUMMARY OF THE INVENTION

The present invention has been made to overcome such a conventional problem and aims at providing a connector capable of connecting a conductor portion of an electric wire to a connection object while the number of components is small and preventing breakage of the conductor portion of the electric wire even when tensile forces are applied to the electric wire led out from a housing from various directions.

A connector according to the present invention is one connecting a conductor portion of an electric wire to a connection object, the connector comprising:
a housing accommodating an end of the connection object and an end of the electric wire,
wherein the connection object and the conductor portion of the electric wire make contact with and are electrically connected to each other in the housing,
the housing has an electric wire lead-out port leading out the electric wire from inside to outside of the housing,
the electric wire lead-out port has a first contact portion and a second contact portion that make contact with the electric wire at two positions separate away from each other along a length direction of the electric wire so as to disperse a load applied to the electric wire when the electric wire is led out from the housing at a predetermined minimum bending radius determined by a shape of the housing around the electric wire lead-out port.

### BRIEF DESCRIPTION OF THE DRAWINGS

FIG. 1 is a perspective view showing a connector according to an embodiment when viewed from an obliquely upper position.

FIG. 2 is a perspective view showing the connector according to the embodiment when viewed from an obliquely lower position.

FIG. 3 is a plan view showing the connector according to the embodiment.

FIG. 4 is an assembly view of the connector according to the embodiment.

FIG. 5 is a perspective view showing a first insulator used in the connector according to the embodiment.

FIG. 6 is a plan view showing the first insulator used in the connector according to the embodiment.

FIG. 7 is a front view showing the first insulator used in the connector according to the embodiment.

FIG. 8 is an enlarged view of an important part of FIG. 6.

FIG. 9 is an enlarged view of an important part of FIG. 7.

FIG. 10 is a perspective view showing a second insulator used in the connector according to the embodiment.

FIG. 11 is a bottom view showing the second insulator used in the connector according to the embodiment.

FIG. 12 is a front view showing the second insulator used in the connector according to the embodiment.

FIG. 13 is an enlarged view of an important part of FIG. 11.

FIG. 14 is an enlarged view of an important part of FIG. 12.

FIG. 15 is a front view showing the connector according to the embodiment in the process of assembling.

FIG. 16 is a cross-sectional view taken along line A-A in FIG. 3.

FIG. 17 is a partial enlarged cross-sectional view showing an electric wire led out from the connector according to the embodiment.

FIG. 18 is a front view showing the electric wire led out from the connector according to the embodiment.

FIG. 19 is a partial enlarged cross-sectional view showing the electric wire led out from the connector according to the embodiment and being bent.

FIG. 20 is a partial enlarged cross-sectional view showing the electric wire led out from a connector according to a modification of the embodiment.

FIG. 21 is a partial enlarged cross-sectional view showing the electric wire led out from the connector according to the modification of the embodiment and being bent.

FIG. 22 is a partial enlarged cross-sectional view showing an electric wire led out from a connector according to another modification of the embodiment.

FIG. 23 is a partial enlarged cross-sectional view showing the electric wire led out from the connector according to another modification of the embodiment and being bent.

FIG. 24 is a partial enlarged cross-sectional view showing the electric wire led out from a connector according to yet another modification of the embodiment.

FIG. 25 is a partial enlarged cross-sectional view showing the electric wire led out from the connector according to yet another modification of the embodiment and being bent.

FIG. 26 is a perspective view showing a conventional cable protection device.

### DETAILED DESCRIPTION OF THE INVENTION

An embodiment of the present invention is described below based on the accompanying drawings.

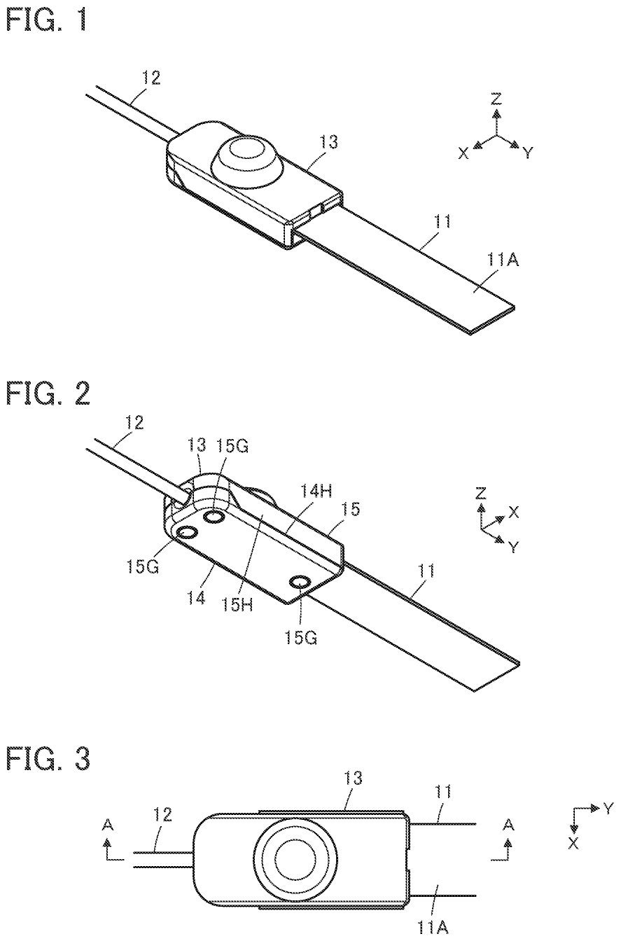

FIGS. 1 to 3 show a connector according to the embodiment. The connector is used to connect a coated electric wire 12 to a sheet type conductive member 11 that is used as a connection object, and the connector includes a housing 13 formed of an insulating resin material.

The sheet type conductive member 11 has a top surface and a bottom surface facing in opposite directions from each other and has a flexible conductor 11A exposed at least on the top surface. As the sheet type conductive member 11, conductive cloth woven using a conductive thread such as silver can be used, for example. When such conductive cloth is used, the flexible conductor 11A is exposed not only on the top surface but also on the bottom surface of the sheet type conductive member 11. In addition, one obtained by applying a conductive ink on a surface of cloth having no conductivity by printing or another method to form the flexible conductor 11A on the surface thereof can also be used as the sheet type conductive member 11. Further, a member obtained by forming the flexible conductor 11A formed of a conductive pattern on a surface of an insulating sheet body such as a resin film may be used as the sheet type conductive member 11.

The sheet type conductive member 11 has a band shape extending in a predetermined direction.

The coated electric wire 12 has a structure in which an outer periphery of a conductor portion to be described later is covered with an insulating coating portion. With the connector according to the embodiment, the conductor portion of the coated electric wire 12 is electrically connected to the flexible conductor 11A of the sheet type conductive member 11.

On the opposite side from the sheet type conductive member 11 of band shape across the housing 13, the coated electric wire 12 extends in the same direction as the direction in which the sheet type conductive member 11 extends.

For convenience, the sheet type conductive member 11 of band shape is defined as extending along an XY plane, the direction in which the coated electric wire 12 extends toward the housing 13 is referred to as “+Y direction,” and the direction orthogonal to an XY plane is referred to as “Z direction.”

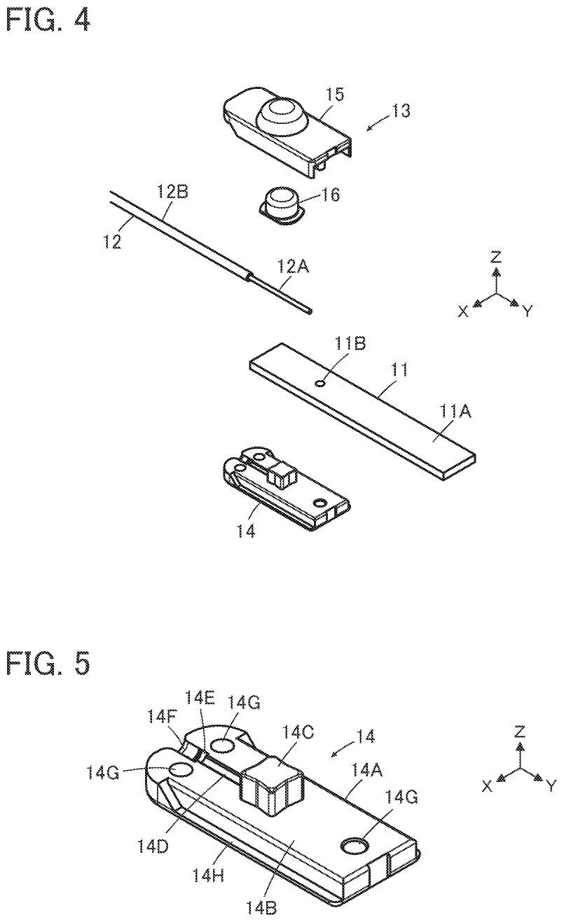

FIG. 4 shows an assembly view of the connector. The connector includes a first insulator 14 and a second insulator 15, and these first and second insulators 14 and 15 constitute the housing 13.

The sheet type conductive member 11 is disposed on the +Z direction side of the first insulator 14, and a conductor portion 12A exposed from an insulating coating portion 12B of the coated electric wire 12 is disposed on the +Z direction side of the sheet type conductive member 11. The conductor portion 12A of the coated electric wire 12 may be either of a so-called solid wire that is formed of one conductor and a so-called stranded wire that is formed by twisting a plurality of conductors.

In addition, the connector includes a contact force-securing member 16. The contact force-securing member 16 is disposed on the +Z direction side of the conductor portion 12A of the coated electric wire 12, and the second insulator 15 is disposed on the +Z direction side of the contact force-securing member 16.

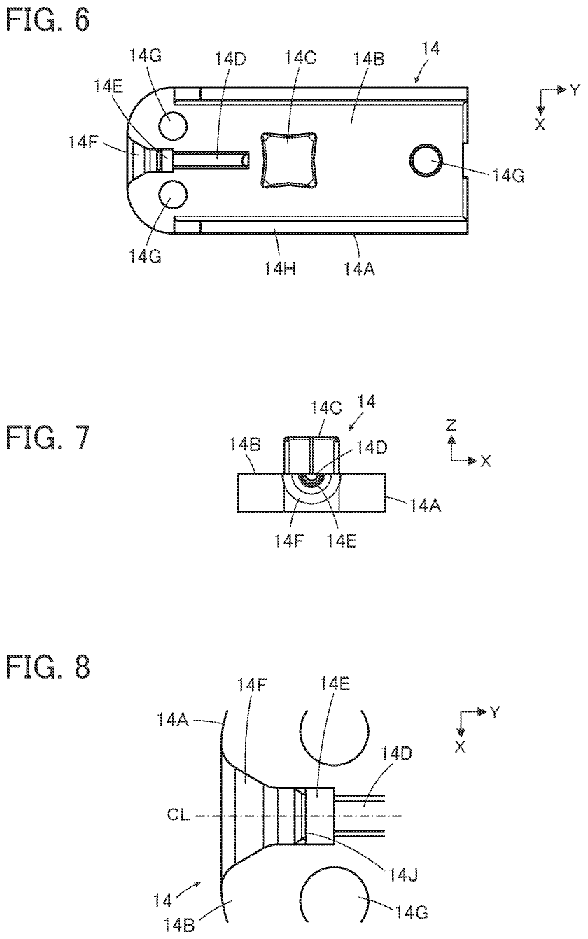

FIGS. 5 to 7 show the first insulator 14. The first insulator 14 includes a flat plate portion 14A of substantially rectangular shape extending along an XY plane, and a +Z directional surface of the flat plate portion 14A forms a first retaining surface 14B extending along an XY plane and facing in +Z direction. The first retaining surface 14B is provided with a protrusion portion 14C of substantially prismatic shape protruding toward the +Z direction.

In addition, the first retaining surface 14B is provided with a first conductor insertion groove 14D extending in the Y direction on the −Y direction side from the protrusion portion 14C, a first insulating coating insertion groove 14E communicating with a −Y directional end of the first conductor insertion groove 14D, and a first lead-out groove 14F communicating with a −Y directional end of the first insulating coating insertion groove 14E and extending up to an outer surface of a −Y directional end of the first insulator 14.

Further, the flat plate portion 14A includes three through-holes 14G separately formed on opposite sides of the first insulating coating insertion groove 14E in the X direction and near a +Y directional end of the flat plate portion 14A and penetrating the flat plate portion 14A in the Z direction.

In addition, step portions 14H extending in the Y direction are separately formed at X-directional opposite lateral surfaces of the flat plate portion 14A.

As shown in FIG. 8, the first conductor insertion groove 14D, the first insulating coating insertion groove 14E, and the first lead-out groove 14F are formed coaxially with one another and have a common central axis CL. The first conductor insertion groove 14D has a groove width corresponding to the diameter of the conductor portion 12A of the coated electric wire 12, while the first insulating coating insertion groove 14E has a groove width corresponding to the outer diameter of the insulating coating portion 12B of the coated electric wire 12. The first lead-out groove 14F has the same groove width as that of the first insulating coating insertion groove 14E at its +Y directional end communicating with the first insulating coating insertion groove 14E, and has a shape with the groove width gradually increasing toward the −Y direction along the central axis CL.

At an intermediate part in the Y direction of the first insulating coating insertion groove 14E, a projection 14J is formed to project from the bottom surface of the first insulating coating insertion groove 14E toward the inside of the first insulating coating insertion groove 14E in an XZ plane.

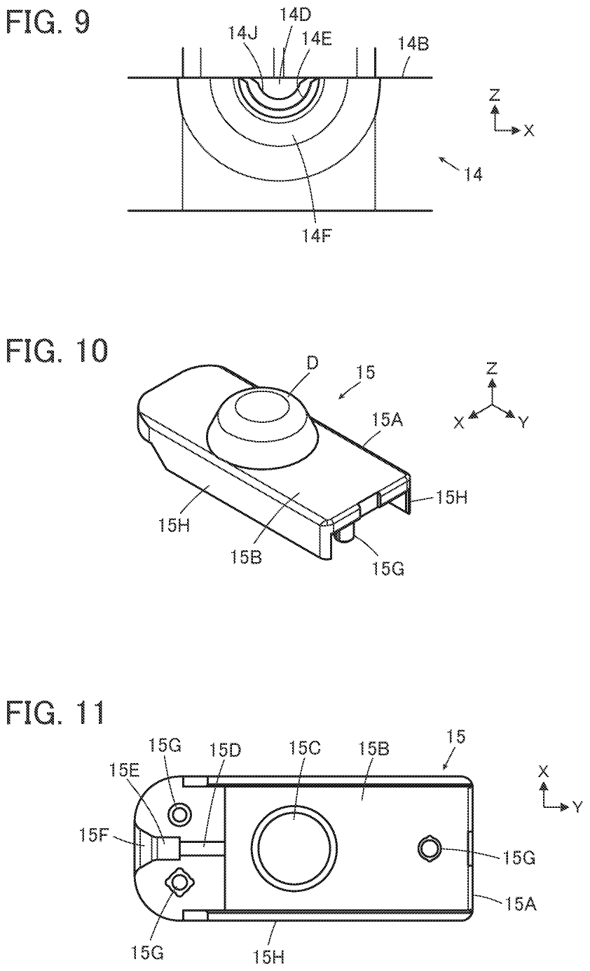

The projection 14J has a semicircular shape when viewed in the Y direction along the central axis CL as shown in FIG. 9, and has a projection height smaller than the thickness of the insulating coating portion 12B of the coated electric wire 12.

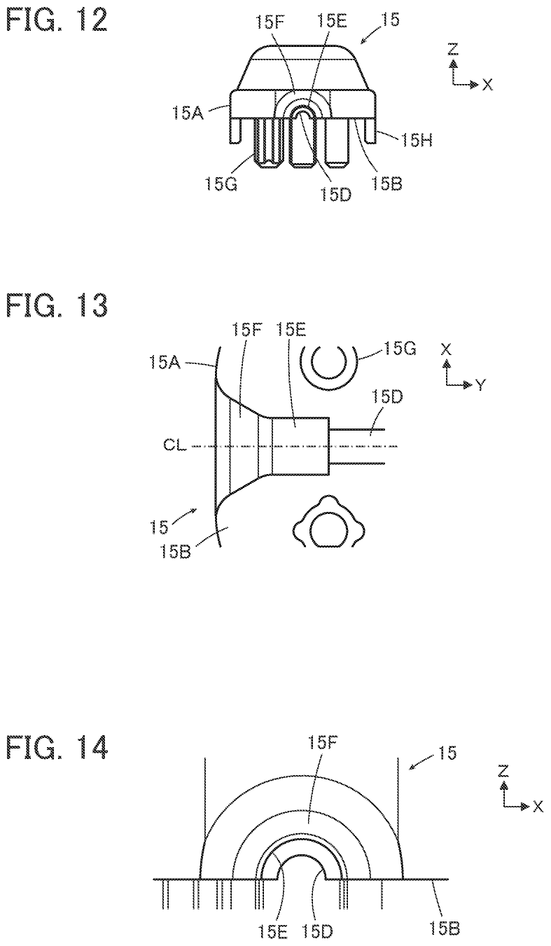

FIGS. 10 to 12 shows the second insulator 15. The second insulator 15 includes a flat plate portion 15A of substantially rectangular shape extending along an XY plane, and a −Z directional surface of the flat plate portion 15A forms a second retaining surface 15B extending along an XY plane and facing in the −Z direction. A dome-shaped portion D is formed on the +Z direction side of the flat plate portion 15A to project from the flat plate portion 15A toward the +Z direction, and the second retaining surface 15B is provided with a recessed portion 15C extending to the inside of the dome-shaped portion D and opening toward the −Z direction.

In addition, the second retaining surface 15B is provided with: a second conductor insertion groove 15D extending in the Y direction on the −Y direction side from the recessed portion 15C; a second insulating coating insertion groove 15E communicating with a −Y directional end of the second conductor insertion groove 15D; and a second lead-out groove 15F communicating with a −Y directional end of the second insulating coating insertion groove 15E and extending up to an outer surface of a −Y directional end of the second insulator 15.

Further, the flat plate portion 15A includes three bosses 15G separately formed on opposite sides of the second insulating coating insertion groove 15E in the X direction and near a +Y directional end of the flat plate portion 15A and projecting in the −Z direction.

In addition, a pair of lateral plates 15H protruding in the −Z direction and extending in the Y direction are separately formed at X-directional opposite lateral portions of the flat plate portion 15A.

As shown in FIG. 13, the second conductor insertion groove 15D, the second insulating coating insertion groove 15E, and the second lead-out groove 15F are formed coaxially with one another and have the common central axis CL. The second conductor insertion groove 15D has a groove width corresponding to the diameter of the conductor portion 12A of the coated electric wire 12, while the second insulating coating insertion groove 15E has a groove width corresponding to the outer diameter of the insulating coating portion 12B of the coated electric wire 12. The second lead-out groove 15F has the same groove width as that of the second insulating coating insertion groove 15E at its +Y directional end communicating with the second insulating coating insertion groove 15E, and has a shape with the groove width gradually increasing toward the −Y direction along the central axis CL.

As shown in FIG. 14, the second insulating coating insertion groove 15E of the second insulator 15 is provided with no projection projecting from the bottom surface of the second insulating coating insertion groove 15E toward the inside of the second insulating coating insertion groove 15E.

When the first insulator 14 and the second insulator 15 are joined to each other to form the housing 13, the first conductor insertion groove 14D of the first insulator 14 and the second conductor insertion groove 15D of the second insulator 15 are disposed to face each other to thereby retain the conductor portion 12A of the coated electric wire 12, and the first insulating coating insertion groove 14E of the first insulator 14 and the second insulating coating insertion groove 15E of the second insulator 15 are disposed to face each other to constitute an electric wire fixing portion of cylindrical shape that fastens an outer periphery of the insulating coating portion 12B of the coated electric wire 12 and fixes the coated electric wire 12.

Further, when the first insulator 14 and the second insulator 15 are joined to each other to form the housing 13, the first lead-out groove 14F of the first insulator 14 and the second lead-out groove 15F of the second insulator 15 are disposed to face each other to constitute an electric wire lead-out port that leads out the coated electric wire 12 from the inside to the outside of the housing 13.

As shown in FIG. 4, the sheet type conductive member 11 is provided with a through-hole 11B corresponding to a +Y directional boss 15G on the second insulator 15.

In addition, the contact force-securing member 16 shown in FIG. 4 is formed of a metal material and has a cylindrical shape. The contact force-securing member 16 is, when the connector is assembled, disposed between the recessed portion 15C of the second insulator 15 and the protrusion portion 14C of the first insulator 14 and secures the contact force between the conductor portion 12A of the coated electric wire 12 and the flexible conductor 11A of the sheet type conductive member 11 contacting each other.

When the connector as above is assembled, the contact force-securing member 16 is inserted into the recessed portion 15C of the second insulator 15 from the −Z direction, and the three bosses 15G of the second insulator 15 are separately inserted into the three through-holes 14G of the first insulator 14 with a +Y directional end of the coated electric wire 12 and a −Y directional end of the sheet type conductive member 11 being sandwiched between the first retaining surface 14B of the first insulator 14 and the second retaining surface 15B of the second insulator 15, whereby the first insulator 14 and the second insulator 15 are joined to each other.

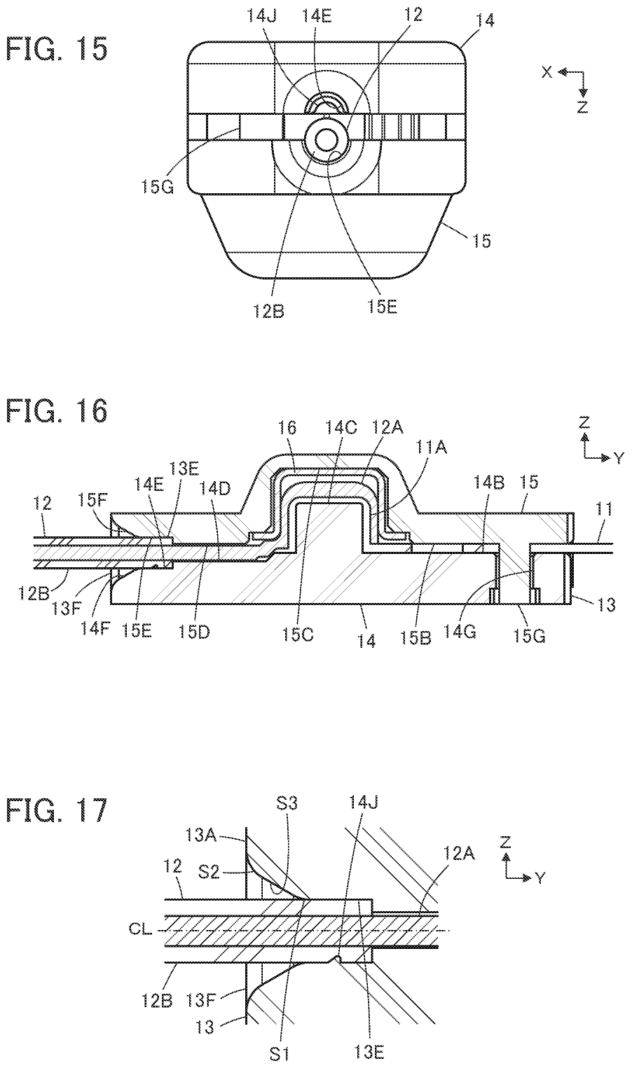

When the first insulator 14 and the second insulator 15 are joined to each other, as shown in FIG. 15, first, a +Z directional end of the insulating coating portion 12B of the coated electric wire 12 is inserted in the second insulating coating insertion groove 15E of the second insulator 15. At this time, since the second insulating coating insertion groove 15E has the groove width corresponding to the outer diameter of the insulating coating portion 12B of the coated electric wire 12, and the second insulating coating insertion groove 15E is provided with no projection projecting from the bottom surface of the second insulating coating insertion groove 15E, the coated electric wire 12 is correctly inserted in the second insulating coating insertion groove 15E without misalignment with respect to the second insulating coating insertion groove 15E.

When the first insulator 14 is pressed toward the second insulator 15 in the +Z direction in this state, the first insulating coating insertion groove 14E of the first insulator 14 overlay the coated electric wire 12 so as to cover a −Z directional portion of the insulating coating portion 12B of the coated electric wire 12; however, since the first insulating coating insertion groove 14E is provided with the projection 14J projecting from the bottom surface of the first insulating coating insertion groove 14E toward the inside of the first insulating coating insertion groove 14E, the projection 14J bites into the −Z directional portion of the insulating coating portion 12B of the coated electric wire 12.

That is, when the first insulator 14 and the second insulator 15 are joined to each other to form the housing 13, the coated electric wire 12 is fixed to the housing 13 by means of the projection 14J biting into the −Z directional portion of the insulating coating portion 12B while being kept to be correctly positioned with respect to the second insulating coating insertion groove 15E of the second insulator 15, whereby the coated electric wire 12 is prevented from being pulled out from the housing 13.

When the first insulator 14 is pressed against the second insulator 15, the three bosses 15G of the second insulator 15 separately penetrate the three through-holes 14G of the first insulator 14. In this process, the boss 15G situated on the +Y direction side among the three bosses 15G penetrates the corresponding through-hole 14G of the first insulator 14 through the through-hole 11B of the sheet type conductive member 11 shown in FIG. 4.

In addition, as shown in FIG. 2, the pair of lateral plates 15H of the second insulator 15 are fitted in the pair of step portions 14H of the first insulator 14.

Tips of the three bosses 15G projecting on the −Z direction side of the first insulator 14 are then thermally deformed, whereby the first insulator 14 and the second insulator 15 are fixed to each other to form the housing 13. Thus, the assembling operation of the connector is completed.

FIG. 16 shows the inside of the connector assembled as above. The sheet type conductive member 11 and the conductor portion 12A of the coated electric wire 12 are inserted, by means of the protrusion portion 14C of the first insulator 14, in the inside of the contact force-securing member 16 disposed inside the recessed portion 15C of the second insulator 15 and deform to conform to a surface of the protrusion portion 14C. Thus, the conductor portion 12A of the coated electric wire 12 is sandwiched between the top surface of the sheet type conductive member 11 and the inner surface of the contact force-securing member 16, is brought into contact with the flexible conductor 11A exposed on the top surface of the sheet type conductive member 11 at a predetermined contact force, and is electrically connected to the flexible conductor 11A.

In addition, the conductor portion 12A drawn in the +Y direction from the insulating coating portion 12B of the coated electric wire 12 is inserted in the first conductor insertion groove 14D of the first insulator 14 and the second conductor insertion groove 15D of the second insulator 15.

Further, in the state where the +Y directional end of the insulating coating portion 12B is accommodated in and fixed to the electric wire fixing portion 13E of cylindrical shape formed by the first insulating coating insertion groove 14E of the first insulator 14 and the second insulating coating insertion groove 15E of the second insulator 15, the coated electric wire 12 is led out in the −Y direction from the electric wire lead-out port 13F formed by the first lead-out groove 14F of the first insulator 14 and the second lead-out groove 15F of the second insulator 15.

As shown in FIG. 17, the electric wire lead-out port 13F has a so-called horn shape gradually expanding from the electric wire fixing portion 13E of cylindrical shape toward the −Y direction along the central axis CL of the electric wire fixing portion 13E. Specifically, the electric wire lead-out port 13F has a first contact portion S1 connected to the electric wire fixing portion 13E on the −Y direction side of the electric wire fixing portion 13E, a second contact portion S2 connected to the outer surface 13A on the −Y direction side of the housing 13, and a tapered portion S3 disposed between the first contact portion S1 and the second contact portion S2 and connecting the first contact portion S1 and the second contact portion S2 with each other.

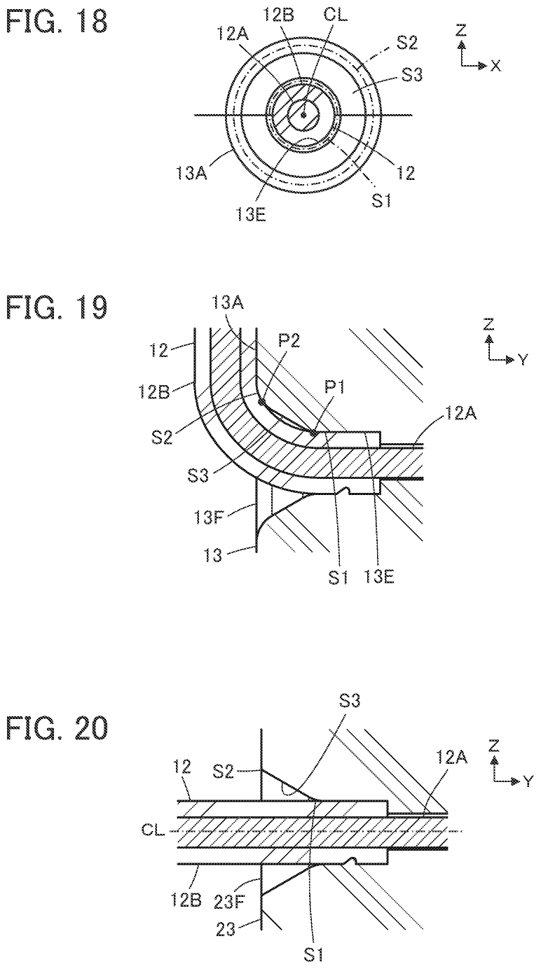

As shown in FIG. 18, when viewed from the −Y direction along the central axis CL of the electric wire fixing portion 13E, the first contact portion S1 has a circular ring shape surrounding the central axis CL at a position adjacent to the electric wire fixing portion 13E, and the second contact portion S2 has a circular ring shape surrounding the central axis CL in the vicinity of the outer surface 13A of the housing 13 and having a radius larger than that of the first contact portion S1.

In addition, as shown in FIG. 17, the first contact portion S1 and the second contact portion S2 each have such a curved shape as to protrude toward the central axis CL in a cross section passing the central axis CL of the electric wire fixing portion 13E.

The tapered portion S3 disposed between the first contact portion S1 and the second contact portion S2 has a conical surface expanding toward the outer surface 13A of the housing 13, and is represented by a pair of line segments each inclined with respect to the central axis CL in FIG. 17.

Here, as shown in FIG. 19, the case is assumed where the coated electric wire 12 is bent to contact the outer surface 13A of the housing 13 and extend toward the +Z direction along the outer surface 13A. At this time, the coated electric wire 12 is led out from the housing 13 at a predetermined minimum bending radius determined by the shape of the housing 13, specifically, the shape of the outer surface 13A, around the electric wire lead-out port 13F, and a tensile force is applied to the coated electric wire 12 from the +Z direction. However, since the electric wire lead-out port 13F has the first contact portion S1 and the second contact portion S2, the electric wire lead-out port 13F contacts the coated electric wire 12 at each of a first contact point P1 situated on the first contact portion S1 and a second contact point P2 situated on the second contact portion S2, and does not contact and is situated away from the coated electric wire 12 at the tapered portion S3 between these first and second contact points P1 and P2.

That is, the electric wire lead-out port 13F contacts the coated electric wire 12 at each of the first contact portion S1 and the second contact portion S2 that are disposed at two positions separate from each other along the length direction of the coated electric wire 12, and the coated electric wire 12 is led out from the housing 13 at the predetermined minimum bending radius, whereby a load applied to the coated electric wire 12 is dispersed. Therefore, it is possible to prevent breakage of the conductor portion 12A of the coated electric wire 12 without using, for example, such a bendable bushing member made of a rubber or the like as that in the conventional cable protection device shown in FIG. 26.

In addition, even when the coated electric wire 12 is bent to contact the outer surface 13A of the housing 13 and extend in various directions other than the +Z direction along the outer surface 13A so that tensile forces are applied from the various direction to the coated electric wire 12, similarly, the electric wire lead-out port 13F contacts the coated electric wire 12 at each of the first contact portion S1 and the second contact portion S2 that are disposed at two positions away from each other along the length direction of the coated electric wire 12, and loads applied to the coated electric wire 12 are dispersed, whereby breakage of the conductor portion 12A of the coated electric wire 12 is prevented.

Note that the tapered portion S3 of the electric wire lead-out port 13F is not limited to one having a conical surface as long as it has a shape that does not contact the coated electric wire 12.

In addition, while the first contact portion S1 and the second contact portion S2 of the electric wire lead-out port 13F each have such a curved shape as to protrude toward the central axis CL of the electric wire fixing portion 13E in the embodiment above, the invention is not limited thereto.

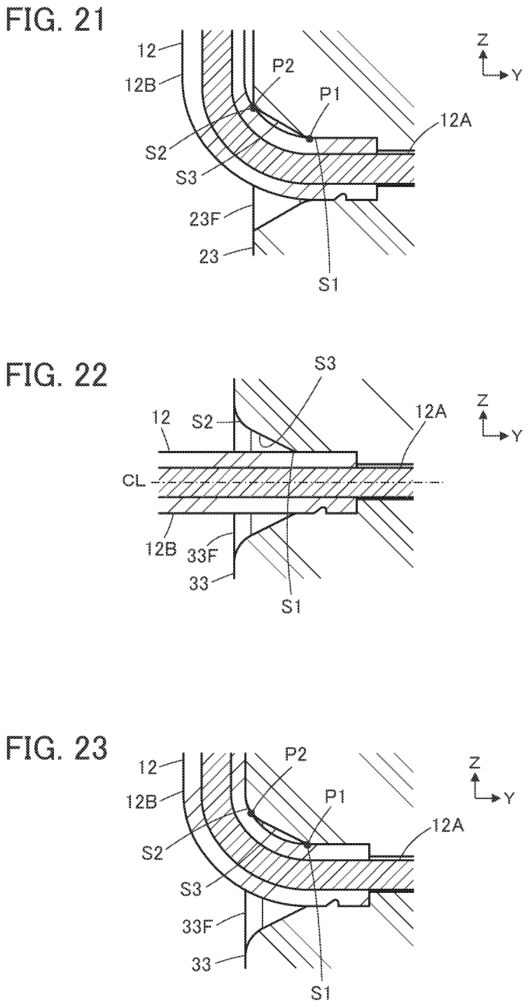

For example, in an electric wire lead-out port 23F of a housing 23 shown in FIG. 20, a first contact portion S1 has such a curved shape as to protrude toward the central axis CL, but a second contact portion S2 has an angular shape. Even in the electric wire lead-out port 23F as above, as shown in FIG. 21, when the coated electric wire 12 is led out from the housing 23 at a predetermined minimum bending radius, the electric wire lead-out port 23F contacts the coated electric wire 12 at each of a first contact point P1 on the first contact portion S1 and a second contact point P2 on the second contact portion S2 that are disposed at two positions away from each other along the length direction of the coated electric wire 12, and a load applied to the coated electric wire 12 is dispersed, whereby breakage of the conductor portion 12A of the coated electric wire 12 can be prevented.

In addition, in an electric wire lead-out port 33F of a housing 33 shown in FIG. 22, a first contact portion S1 has an angular shape, while a second contact portion S2 has such a curved shape as to protrude toward the central axis CL. Even in the electric wire lead-out port 33F as above, as shown in FIG. 23, when the coated electric wire 12 is led out from the housing 33 at a predetermined minimum bending radius, the electric wire lead-out port 33F contacts the coated electric wire 12 at each of a first contact point P1 on the first contact portion S1 and a second contact point P2 on the second contact portion S2 that are disposed at two positions away from each other along the length direction of the coated electric wire 12, and a load applied to the coated electric wire 12 is dispersed, whereby breakage of the conductor portion 12A of the coated electric wire 12 can be prevented.

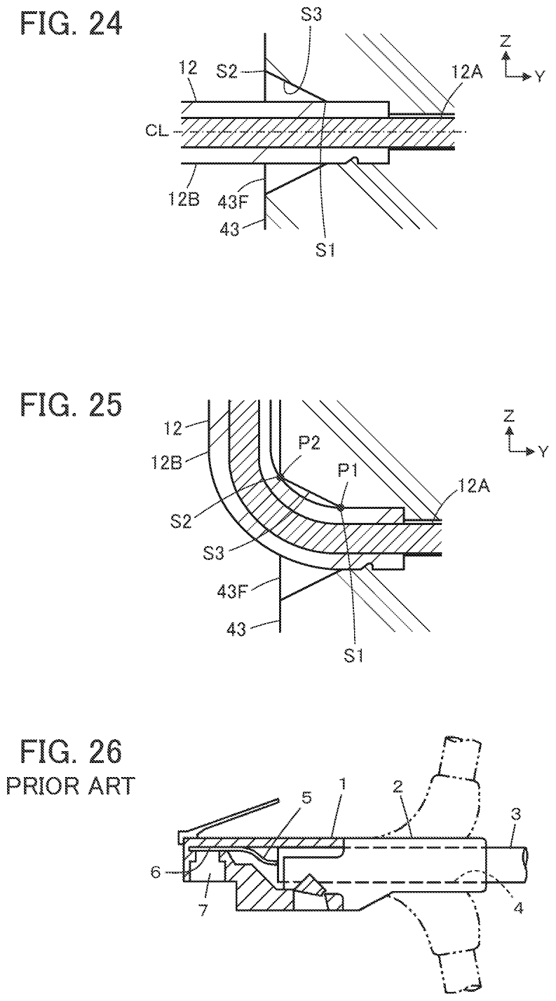

Further, in an electric wire lead-out port 43F of a housing 43 shown in FIG. 24, a first contact portion S1 and a second contact portion S2 both have an angular shape. Even in the electric wire lead-out port 43F as above, as shown in FIG. 25, when the coated electric wire 12 is led out from the housing 43 at a predetermined minimum bending radius, the electric wire lead-out port 43F contacts the coated electric wire 12 at each of a first contact point P1 on the first contact portion S1 and a second contact point P2 on the second contact portion S2 that are disposed at two positions away from each other along the length direction of the coated electric wire 12, and a load applied to the coated electric wire 12 is dispersed, whereby breakage of the conductor portion 12A of the coated electric wire 12 can be prevented.

When the connector of the embodiment is applied to smart clothes, and an electrode (not shown) is connected to the flexible conductor 11A of the sheet type conductive member 11, the electrode disposed at a measurement position and a wearable device can be connected to each other by means of the inexpensive coated electric wire 12 with low electric resistance.

By using a water-resistant adhesive to seal between the first insulator 14 and the second insulator 15, it is possible to configure a waterproof connector that prevents entry of water into a site of electric connection between the flexible conductor 11A of the sheet type conductive member 11 and the conductor portion 12A of the coated electric wire 12.

While the contact force-securing member 16 is used to secure the contact force between the conductor portion 12A of the coated electric wire 12 and the flexible conductor 11A of the sheet type conductive member 11 contacting each other in the embodiment as above, it is possible to configure the connector in which the conductor portion 12A of the coated electric wire 12 and the flexible conductor 11A of the sheet type conductive member 11 are electrically connected with each other between the protrusion portion 14C of the first insulator 14 and the recessed portion 15C of the second insulator 15 without using the contact force-securing member 16.

In addition, while the three bosses 15G of the second insulator 15 penetrate the three through-holes 14G of the first insulator 14 in the embodiment described above, it is possible to configure the connector in which, conversely, a plurality of bosses formed in the first insulator 14 penetrate a plurality of through-holes formed in the second insulator 15.

What is claimed is:

1. A connector connecting a conductor portion of an electric wire to a connection object, the connector comprising:
a housing accommodating an end of the connection object and an end of the electric wire,
wherein the connection object and the conductor portion of the electric wire make contact with and are electrically connected to each other in the housing,
the housing has an electric wire lead-out port leading out the electric wire from inside to outside of the housing,
the electric wire lead-out port has a first contact portion and a second contact portion that make contact with the electric wire at two positions separate away from each other along a length direction of the electric wire so as to disperse a load applied to the electric wire when the electric wire is led out from the housing at a predetermined minimum bending radius determined by a shape of the housing around the electric wire lead-out port.

2. The connector according to claim 1,
wherein the electric wire includes an insulating coating portion covering an outer periphery of the conductor portion,
the housing has an electric wire fixing portion of cylindrical shape that is disposed inside the housing and fixes the electric wire by fastening the insulating coating portion of the electric wire,
the electric wire lead-out port has a shape extending from the electric wire fixing portion along a central axis of the cylindrical shape and expanding toward an outer surface of the housing,
the first contact portion has a circular ring shape surrounding the central axis at a position adjacent to the electric wire fixing portion, and
the second contact portion has a circular ring shape surrounding the central axis in a vicinity of the outer surface of the housing and having a radius larger than that of the first contact portion.

3. The connector according to claim 2,
wherein the housing is composed of a first insulator having a first retaining surface and a second insulator having a second retaining surface facing the first retaining surface and joined to the first insulator, and
the electric wire fixing portion and the electric wire lead-out port are formed by the first insulator and the second insulator.

4. The connector according to claim 3,
wherein the first insulator includes: a first conductor insertion groove which is formed in the first retaining surface and in which the conductor portion of the electric wire is inserted; a first insulating coating insertion groove which is formed in the first retaining surface so as to communicate with the first conductor insertion groove and in which the insulating coating portion of the electric wire is inserted; and a first lead-out groove formed in the first retaining surface so as to communicate with the first insulating coating insertion groove,
the second insulator includes: a second conductor insertion groove which is formed in the second retaining surface and in which the conductor portion of the electric wire is inserted; a second insulating coating insertion groove which is formed in the second retaining surface so as to communicate with the second conductor insertion groove and in which the insulating coating portion of the electric wire is inserted; and a second lead-out groove formed in the second retaining surface so as to communicate with the second insulating coating insertion groove,
the electric wire fixing portion is formed by the first insulating coating insertion groove and the second insulating coating insertion groove being disposed to face each other, and
the electric wire lead-out port is formed by the first lead-out groove and the second lead-out groove being disposed to face each other.

5. The connector according to claim 4, wherein a projection projecting to inside of the electric wire fixing portion and biting into the insulating coating portion of the electric wire is formed in either of the first insulating coating insertion groove and the second insulating coating insertion groove.

6. The connector according to claim 5, wherein the projection has a semicircular shape when viewed in a direction along the central axis.

7. The connector according to claim 2, wherein the electric wire lead-out port has a tapered portion disposed between the first contact portion and the second contact portion and constituted of a conical surface expanding toward the outside of the housing.

8. The connector according to claim 2, wherein at least one of the first contact portion and the second contact portion has a curved shape in a cross section passing the central axis.

9. The connector according to claim 2, wherein the first contact portion and the second contact portion both have an angular shape in a cross section passing the central axis.

10. The connector according to claim 3,
wherein the first insulator includes a protrusion portion formed to protrude on the first retaining surface,
the second insulator includes a recessed portion formed in the second retaining surface and corresponding to the protrusion portion,
the first insulator and the second insulator are joined to each other with the connection object and the electric wire being sandwiched between the first retaining surface and the second retaining surface, and
at least a part of the protrusion portion is accommodated in the recessed portion, whereby the conductor portion of the electric wire is electrically connected to the connection object in the recessed portion.

11. The connector according to claim 1, wherein a flexible conductor of a sheet type conductive member is connected to the conductor portion of the electric wire as the connection object.
